(19) United States
(12) Patent Application Publication
(10) Pub. No.: US 2013/0223782 A1
(43) Pub. Date: Aug. 29, 2013

(54) MECHANICAL FACE SEAL ASSEMBLY FOR BEARINGS

(71) Applicant: Pascal Mandou, Jassans-Riottier (FR)

(72) Inventor: Pascal Mandou, Jassans-Riottier (FR)

(73) Assignee: AKTIEBOLAGET SKF, Goteborg (SE)

(21) Appl. No.: 13/812,832

(22) PCT Filed: Jul. 22, 2011
(86) PCT No.: PCT/US11/44939

§ 371 Date: Mar. 21, 2013

Related U.S. Application Data
(60) Provisional application No. 61/367,711, filed on Jul. 26, 2010.

(51) Int. Cl. F16J 15/34; F16C 33/78

(52) U.S. Cl. CPC F16J 15/34; F16C 33/78
USPC 384/481; 277/358; 277/377; 277/384

(57) ABSTRACT

A seal assembly is provided for sealing a space between a housing and a shaft, the housing having a bore with centerline and the shaft being disposed within the bore and rotatable about a central axis. The seal assembly includes an annular rotary seal member coupled with the shaft and having a radial rotary sealing surface. An annular static seal member is coupled with the housing, disposed about the shaft and has a radial static sealing surface disposed against the rotary sealing surface so as to prevent passage of substances between the two sealing surfaces. The rotary sealing surface is slideable against the static sealing surface as the shaft rotates about the axis and the static member is movable with respect to the housing such that the rotary and static sealing surfaces are substantially juxtaposed when the shaft axis defines an acute angle with respect to the housing centerline.

The present invention relates to seal assemblies, and particularly seal assemblies for sealing space adjacent to a bearing assembly.

Sealing assemblies for sealing the space adjacent to a bearing assembly are known and typically include an elastomeric sealing member with a lip for engaging with the outer surface of the shaft. Typically, the elastomeric sealing member is biased by means of a garter spring to provide a sealing force on the shaft. Although such seal assemblies are generally effective, the sealing member is only capable of sealing at relatively lower pressure and may be unsuitable for higher pressure applications, such as in a centrifugal pump.

### SUMMARY OF THE INVENTION

In one aspect, the present invention is a seal assembly for sealing a space between a housing and a shaft, the housing having a bore with centerline and the shaft being disposed within the bore and rotatable about a central axis. The seal assembly basically comprises a generally annular rotary seal member coupled with the shaft and having a generally radial rotary sealing surface and a generally annular static seal member coupled with the housing. The static seal member is disposed about the shaft and has a generally radial static sealing surface disposed generally against the rotary sealing surface so as to substantially prevent passage of substances between the two sealing surfaces. The rotary sealing surface is slideable against the static sealing surface as the shaft rotates about the central axis and the static member is movable with respect to the housing such that the rotary and static sealing surfaces are substantially juxtaposed when the shaft axis defines an acute angle with respect to the housing centerline.

In another aspect, the present invention is bearing assembly for supporting a shaft within a housing, the housing having opposing axial ends and a bore with centerline and the shaft being disposed within the bore and rotatable about a central axis. The bearing assembly basically comprises a bearing and a seal assembly. The bearing includes an inner race coupled with the shaft, an outer race coupled with the housing and a plurality of rolling elements disposed between the inner and outer races. The seal assembly is disposed at least partially within the bore between the bearing and one axial end of the housing and is configured to substantially prevent substances from passing through the bore between the bearing and the housing axial end. The seal assembly includes a generally annular rotary seal member coupled with the shaft and having a generally radial rotary sealing surface and a generally annular static seal member coupled with the housing. The static seal member is disposed about the shaft and has a generally radial static sealing surface disposed generally against the rotary sealing surface so as to substantially prevent passage of substances between the two sealing surfaces. The rotary sealing surface is slideable against the static sealing surface as the shaft rotates about the central axis and the static member is movable with respect to the housing such that the rotary and static sealing surfaces are substantially juxtaposed when the shaft axis defines an acute angle with respect to the housing centerline.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a first construction of a seal assembly in accordance with the present invention, shown in a preferred bearing application;

FIG. 2 is an enlarged view of an upper portion of FIG. 1;

FIG. 3 is a greatly enlarged view of a central portion of FIG. 1;

FIGS. 4A and 4B, collectively FIG. 4, shown two orientations of the seal assembly, FIG. 4A showing the seal assembly in a substantially collinear orientation and FIG. 4B showing the seal assembly in an angled orientation;

FIG. 5 is an axial cross-sectional view of a second construction of the seal assembly;

FIG. 6 is an enlarged view of a central portion of the seal assembly of FIG. 5;

FIG. 7 is an axial cross-sectional view of a third construction of the seal assembly;

FIG. 8 is an axial cross-sectional view of a fourth construction of the seal assembly;

FIG. 9 is an axial cross-sectional view of a first seal construction, showing a modified structure including optional couplers; and

FIG. 10 is an axial cross-sectional view of the third seal construction of FIG. 8, showing a modified structure having the optional couplers.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

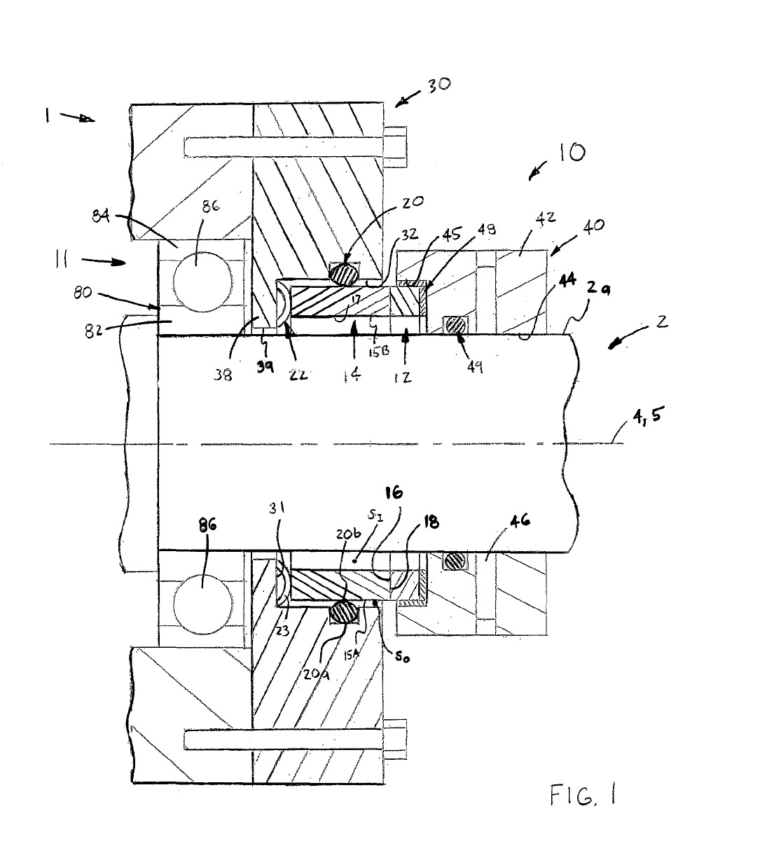

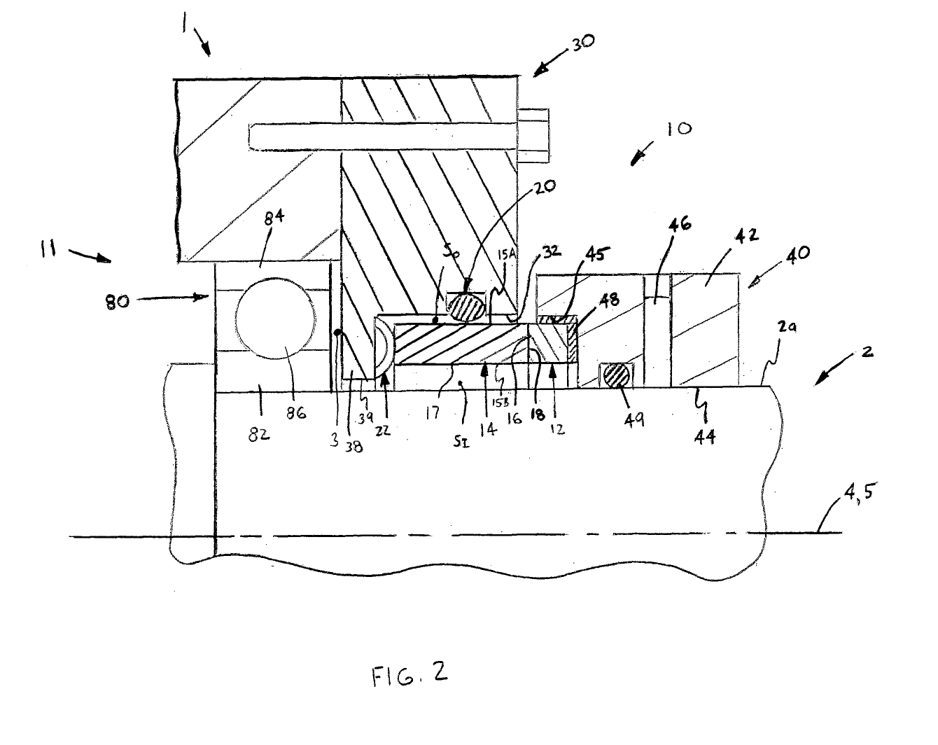

Referring now to the drawings in detail, wherein like numbers are used to indicate like elements throughout, there is shown in FIGS. 1-9 four alternative constructions of a mechanical seal assembly 10 for sealing an annular space between a housing 1 and a shaft 2, preferably incorporated into a bearing assembly 11, as described below. The housing 1 has opposing axial ends 1a, 1b, a bore 3 extending between the ends 1a, 1b, and a centerline 4 extending through the bore 3, and the shaft 2 extends through the bore 3 and is rotatable about a central axis 5. In each construction, the seal assembly 10 basically comprises a generally annular rotary seal member 12 coupled with the shaft 2 and a generally annular static sealing member 14 coupled with the housing 1 and disposed about the shaft 1. The rotary sealing member 12 has a generally radial rotary sealing surface 16 and the static seal member 14 has a generally radial static sealing surface 18 disposed generally against the rotary sealing surface 16 so as to substantially prevent passage of substances between the two sealing surfaces 16, 18. The rotary sealing surface 16 is slideable against the static sealing surface 18 as the shaft 2 rotates about the central axis 5.

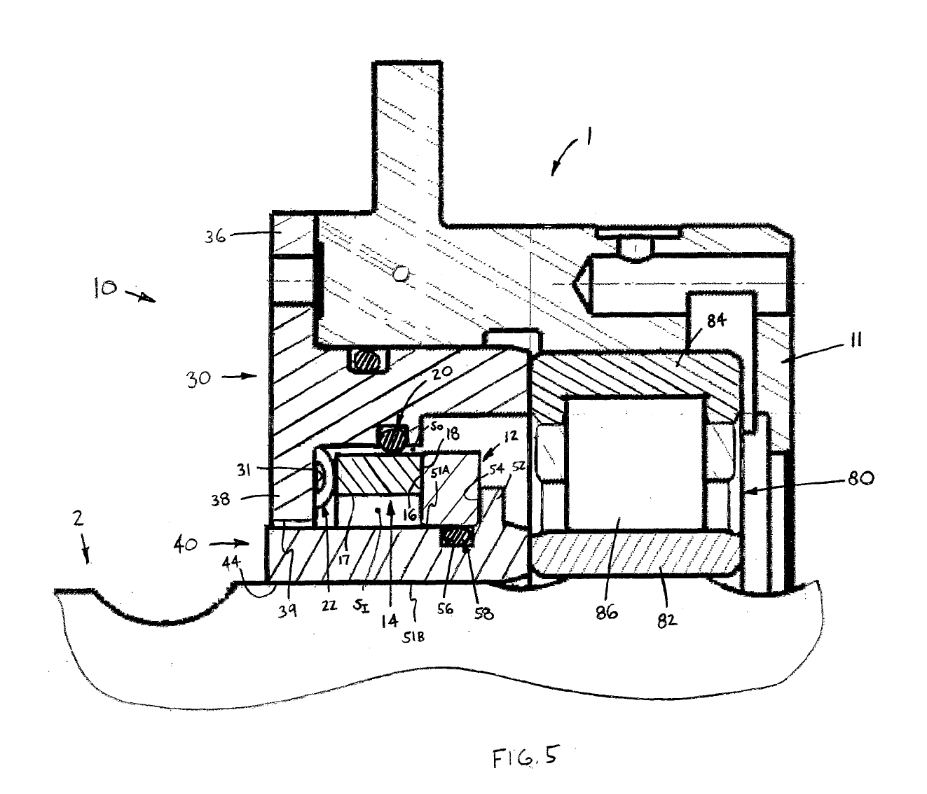

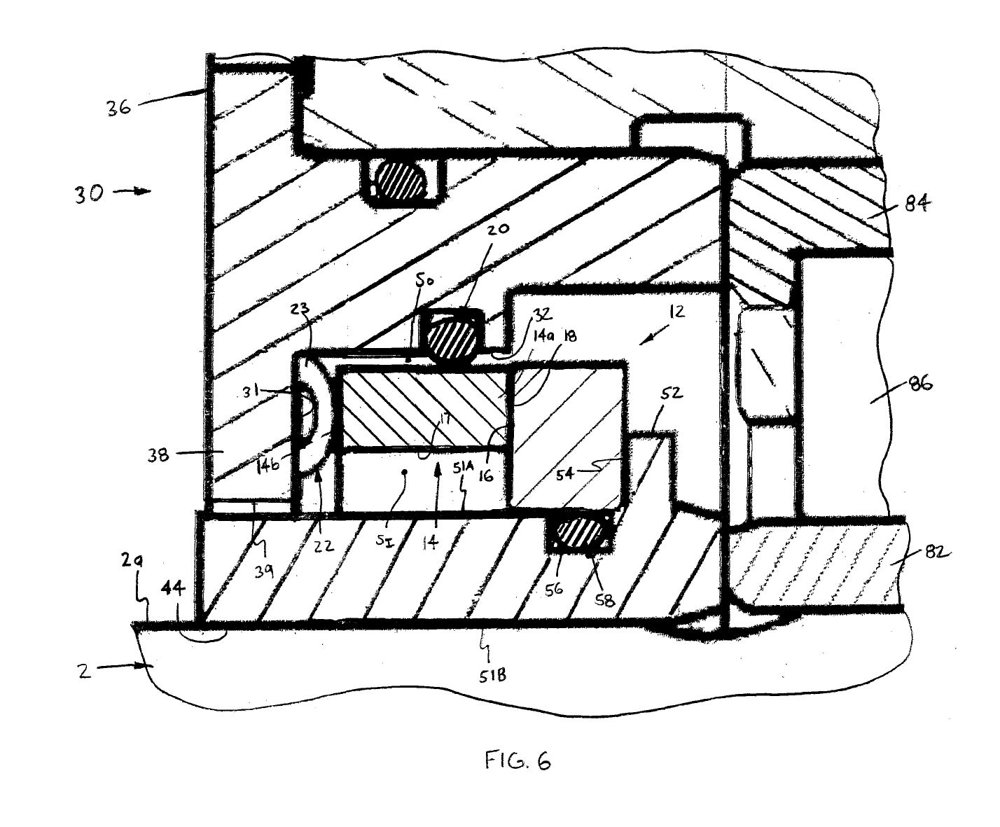

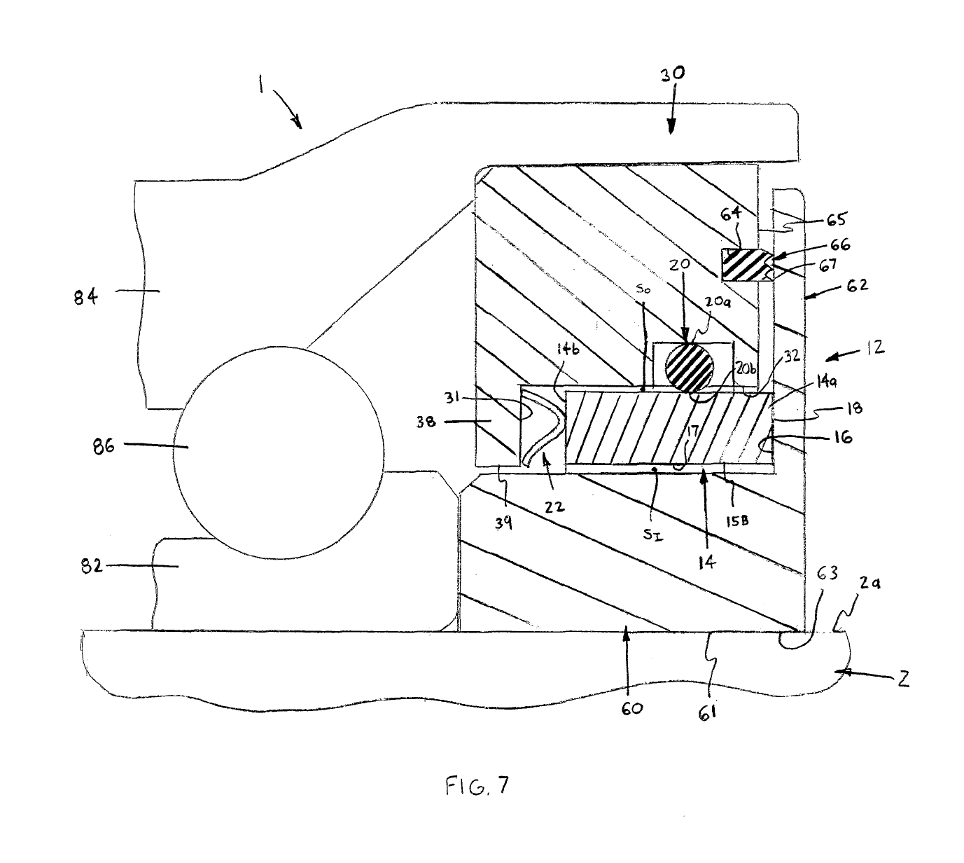

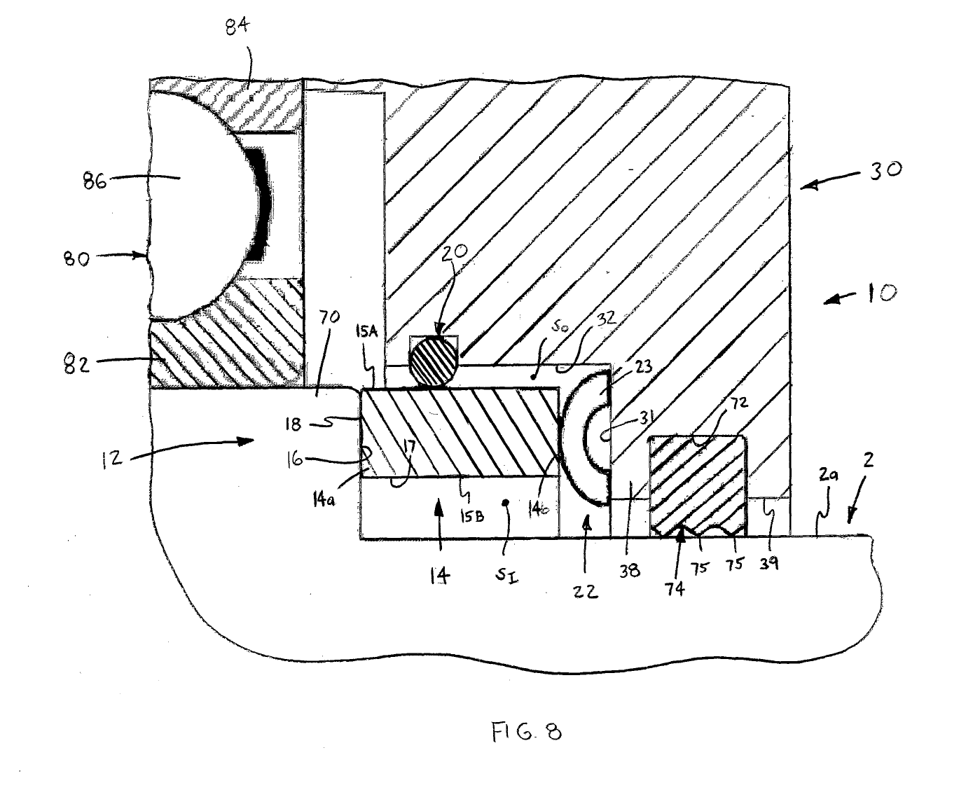

Preferably, a lubricant film is present between the sealing surfaces 16, 18, and the static sealing surface 18 may include one or more generally circumferential beads (not shown) extending generally axially from the static sealing surface 18 and engageable with the rotary sealing surface 16. In the various constructions, the rotary and static sealing members 12, 14 are arranged such that in a first construction (FIGS. 1-4) and a third construction (FIG. 7), the rotary sealing surface 16 faces generally inwardly and toward a center (not indicated) of the housing 1, and in a second construction (FIGS. 5-6) and a fourth construction (FIG. 8), the rotary sealing surface 16 faces generally outwardly and away from the housing center.

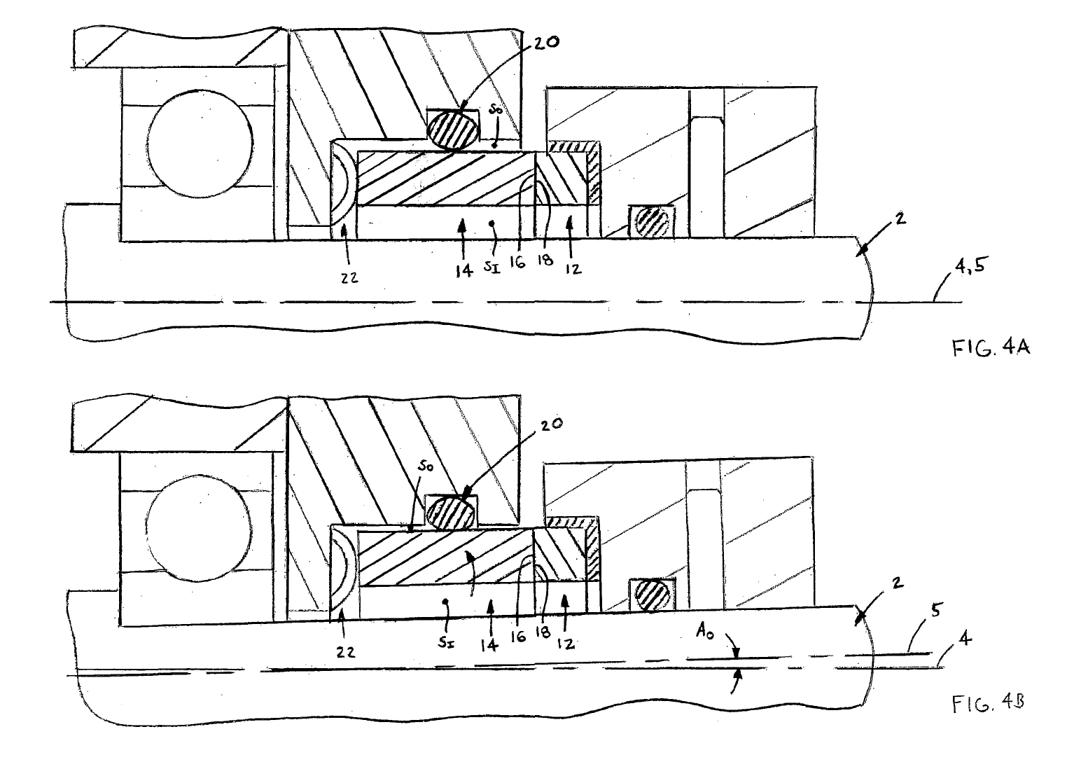

It is important to note that the designation of the sealing member 14 as “static” is only intended to indicate that the member 14 is substantially angularly fixed or “non-rotatable” about the axis 5, but the static sealing member 14 is preferably linearly displaceable along the axis 5 to a certain extent. Specifically, the static member 14 is preferably movable with respect to the housing 1 such that the rotary and static sealing surfaces 16, 18 are substantially juxtaposed even when the shaft axis 5 defines an acute angle A_{O} with respect to the housing centerline 5; i.e., the centerline 4 and axis 5 are not substantially collinear, but instead skewed or intersecting. As such, the static seal member 14 is adjustably positionable, or “self-alignable”, to compensate for misalignment between the shaft 2 and the housing 1, as depicted in FIG. 4 with a first seal assembly construction, each other seal construction being similarly adjustable/positionable. Preferably, the static seal member 14 has outer and inner circumferential surfaces 15A, 15B and opposing axial ends 14a, 14b and the static sealing surface 18 is provided on the first end 14a.

Furthermore, the static seal member 14 is sized such that outer and inner annular clearance spaces S_{O}, S_{I}, respectively, are defined on opposite radial sides of the static seal member 14, the inner surface 15B defining a bore 17. More specifically, the outer clearance space S_{O} is defined between the static member outer surface 15A and an inner circumferential surface of a cover member 30 (as described below) or of the housing 1, and the inner clearance space S_{I} is defined generally between the static member inner surface 15B and an outer circumferential surface 2a of the shaft 2 or of a base member 40 (described below) disposed on the shaft 2. Thereby, the static seal member 14 is movable within the outer and inner clearance spaces S_{O}, S_{I} so as to adjustably position the static member 14 with respect to the housing centerline 4. That is, the clearance spaces S_{O}, S_{I} provide “room” for adjustment of the position of the static member 14 with respect to the radial member 12 so as to maintain a substantially juxtaposed or “face-to-face” contact between the sealing surfaces 16, 18.

Still referring to FIGS. 1-9, the seal assembly 10 preferably further comprises a generally annular elastomeric sealing member 20 disposed generally between the static seal member 14 and the “surrounding” inner surface of either the cover 30 or the housing 1. The elastomeric sealing member 20 is configured to substantially prevent passage of substances through the outer clearance space S_{O} and also to generally radially support or retain the static seal member 14 about the shaft 1. That is, the sealing member 20 maintains the static sealing member 14 at a particular position and orientation with respect to the housing 1 and shaft 2 once adjusted/aligned to provide appropriate face-to-face contact between the rotary and static sealing surfaces 16, 18. Further, with such a supporting structure, the static seal member 14 is slidable within the inner circumference of the elastomeric sealing member 20 when moving within the outer and inner clearance spaces S_{O}, S_{I} during such an adjustment.

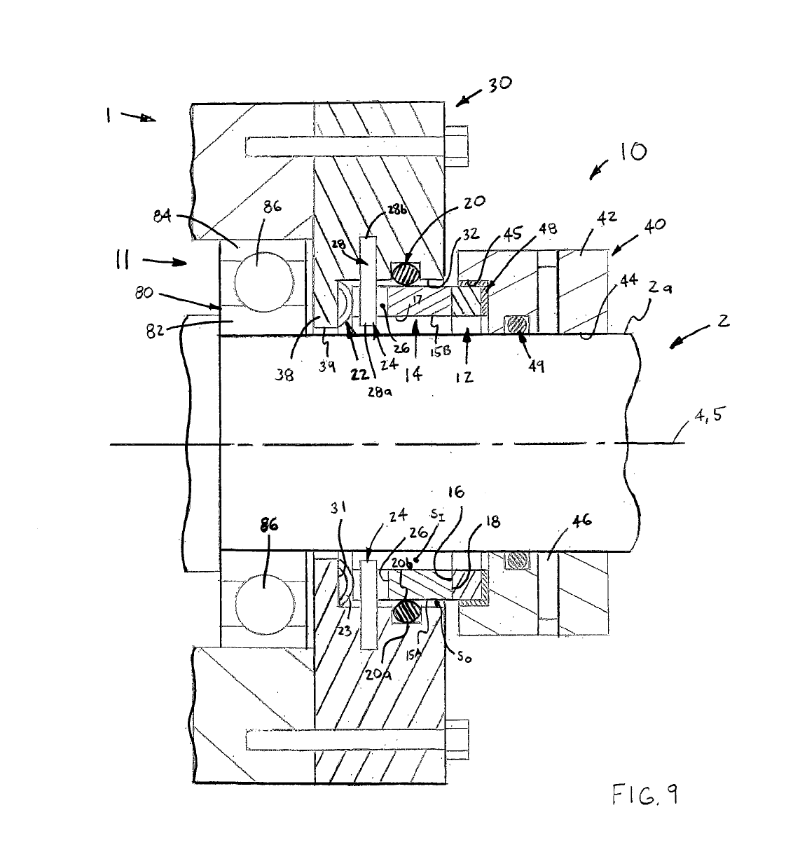

Furthermore, the elastomeric sealing member 14 is preferably also configured to substantially prevent angular displacement of the static sealing member 14 with respect to the central axis 5. Specifically, the sealing member 20 has inner and outer circumferential surfaces 20a, 20b which frictionally engage with the housing and the sealing member 14, respectively, so as to prevent rotation of the sealing member 14 about the axis. Alternatively, the seal assembly 10 may further include one or more coupling members 24 configured to movably couple the sealing member 14 with the housing 1, as shown in FIG. 9 and described in further detail below. Preferably, the elastomeric sealing member 20 is provided by a conventional O-ring, but may be formed in any other appropriate manner.

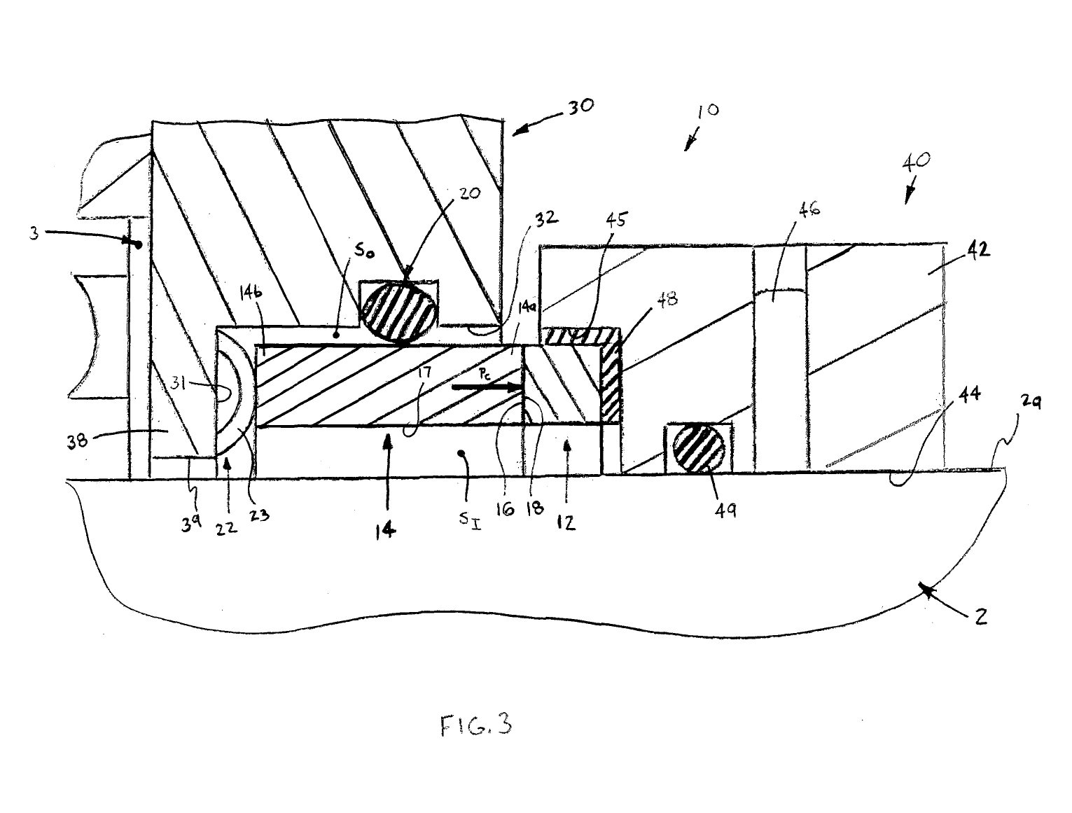

Still referring to FIGS. 1-10, each construction of the seal assembly 10 preferably further comprises at least one biasing member 22 configured to bias the movable static seal member 14 generally toward the rotary seal member 12 so as to maintain a contact pressure P_{C} (indicated in FIG. 3 only) between the static sealing surface 18 and the rotary sealing surface 16. Preferably, the biasing member 22 extends generally axially between a radial surface 31 of the cover member 30, as described below, and the second end 14b of the static seal member 14, and most preferably includes a spring washer 23. Further, the biasing member 22 is preferably sized and/or formed to provide a sealing surface contact pressure P_{C} of up to 0.6 bar. However, the at least one biasing member 22 may be formed in any other appropriate manner, such as for example, a single coil spring disposed about the shaft 2 or a plurality of relatively smaller sized coil springs spaced circumferentially about the shaft axis 5, and/or may be sized to provide any appropriate contact pressure P_{C}.

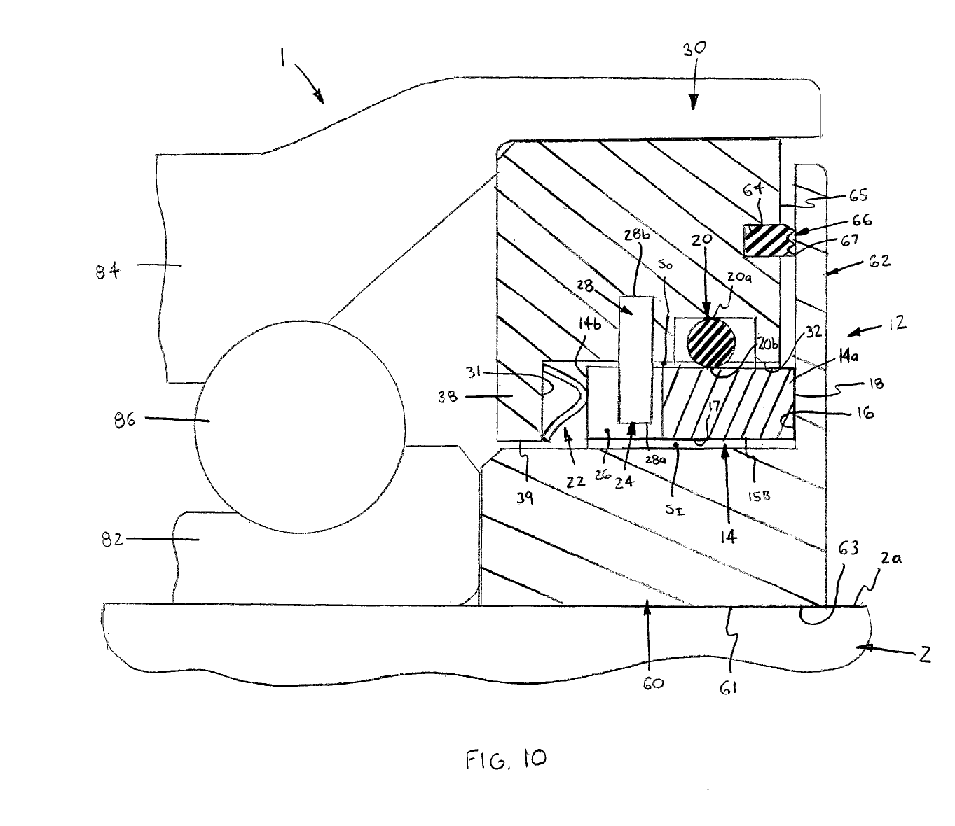

Referring to FIGS. 9 and 10, each seal assembly 10 may alternatively or further include at least one and preferably two couplers 24 each configured to movably couple the static seal member 14 with the housing 1, the two couplers 24 being spaced apart circumferentially about the housing centerline 4, preferably by about 180°. Further, the static member 14 includes at least one and preferably two generally axially-extending slotted openings 26 and each coupler 24 includes a shaft 28 having a first end 28a disposed within a separate one of the slotted openings 26 and a second end 28b fixedly connected with the cover member 30 (or alternatively with the housing 1 if no cover member). Alternatively, the slotted openings 26 may be provided in the cover 30 (or housing 1) and the coupler first ends 28a may be fixedly attached with the static member 14. In either case, the coupler ends 28b (or 28a) are generally axially displaceable within the slotted openings 26 to enable the static seal member 14 to generally pivotably displace relative to the housing centerline 4, and prevented from angularly displacing about the centerline 4, while remaining retained within the housing 1.

Referring again to FIGS. 1-10, as discussed above, the seal assembly 10 preferably further comprises a generally annular cover member 30 disposed about the shaft 2 and connected with the housing 1. The cover 30 has a bore 32 configured to receive at least a portion of the static seal member 14 so as to couple the static member 14 with the housing 1, preferably by means of sealing member 20 or/and by the two couplers 24 described above. By providing the cover member 30, the seal assembly 10 is capable of being provided as a complete unit that is readily adaptable to existing shaft-housing devices, most preferably such devices including bearing assemblies 11, as discussed in further detail below. In a first seal assembly construction depicted in FIGS. 1-4, the cover member 30 is disposed completely externally of the housing 1 and attached thereto by at least one and preferably a plurality of fasteners 34. In a second construction shown in FIGS. 5 and 6, the cover member 30 is partially disposed within the housing 1 and has outwardly extending radial flange 36 attached to the housing 1 by one or more fasteners (none depicted). Further in a third construction shown in FIG. 7, the cover 30 is completely disposed within the housing 1. With the preferred structures of the rotary seal member 12 as described below, the second and third constructions of the seal assembly 10 have minimal axial space requirements and are thus relatively compact in comparison to other seal assemblies.

Further, the cover member 30 includes a generally radially inwardly extending radial shoulder portion 38 providing the radial surface 31 for retaining the biasing member 22, as described above. Preferably, the shoulder portion 38 has an inner circumferential surface 39 spaced radially outwardly from a section of the shaft 2 (FIGS. 1-4), of a base member 40 (as described below) (FIGS. 5 and 6), or of the rotary seal member 12 (FIG. 7) so as to provide a “labyrinth” type of seal. Furthermore, in the second construction of FIGS. 5 and 6, the cover member 30 has an outer circumferential groove 33 and the seal assembly 10 includes an annular elastomeric sealing member 35, preferably an O-ring, disposed within the groove 33 to seal the space between an outer circumferential surface 37 of the cover member 30 and the housing 1.

Referring now to FIGS. 1-6, in the first and second constructions, the seal assembly 10 further comprises a base member 40 mounted on the shaft 2 and configured to connect the rotary seal member 12 with the shaft 2. In both constructions, the base member 40 includes a generally annular body 42 having a central bore 44 configured to receive a portion of the shaft 2, such that the shaft 2 extends through the base member 40 and the base member 40 is connected with the shaft 2. In the first seal assembly construction, the base bore 44 has a counter-bore section 45 configured to receive at least a portion of the rotary seal member 12 so as to thereby couple the rotary seal member 12 with the shaft 2. Further, the first construction seal assembly 10 further includes at least one coupler 46 configured to fixedly mount the base member 40 to the shaft 2, such that the rotary seal member 12 is thereby rotatably fixed with respect to the shaft 2. Preferably, the first construction seal assembly 10 further comprises a generally annular seal member 48 disposed within the base counter-bore section 45 generally between the rotary seal member 12 and the base member 40 and is configured to prevent passage of substances therebetween. Specifically, the seal 48 engages with the axial end 12b of the rotary member 12 opposite the rotary sealing surface 16, and preferably has L-shaped axial cross-sections as depicted, but may have U-shaped cross-sections or any other appropriate shape. Furthermore, the first seal assembly construction also preferably includes a generally annular seal member 49 disposed at least partially within the bore 44 and configured to seal between the base 40 and the shaft 2.

Referring to FIGS. 5 and 6, the base member 40 of the second construction is preferably disposed at least partially within the static member bore 17 and has outer and inner circumferential surfaces 51A, 51B, respectively, the inner surface 51B defining the bore 44, as described above. A shoulder 52 extends generally radially outwardly from the outer surface 51A and circumferentially about the shaft axis 5 and has a generally radial stop surface 54. In the second construction, the rotary seal member 12 is disposed about the base outer surface 51A and has an axial end 14b disposed generally against the shoulder stop surface 54, such that the shoulder 52 axially retains the seal member 12. Further, the base member 40 has an annular groove 56 extending inwardly from the outer surface 51A and a generally annular seal member 58, preferably an O-ring, is disposed within the groove 56 and is configured to substantially prevent passage of substances between the rotary seal member 12 and the base member outer surface 51A.

Referring particularly to FIG. 7, in the third seal construction, the seal assembly 10 is formed without a separate base member and instead the rotary seal member 12 is directly mounted on the shaft 2, with the entire seal assembly 10 being disposed within the housing 1, which preferably includes an integral outer race 84, as described below. Specifically, the rotary seal member 12 includes a generally axial portion 60 disposed at least partially within the static member bore 17 and a generally radial portion 62 providing the rotary sealing member surface 16. The axial portion 60 has an inner circumferential surface 61 defining a central bore 63 configured to receive a portion of the shaft 2, such that the shaft extends through the rotary seal member 12. Further, in the third construction, the cover member 30 preferably has an annular groove 64 extending axially inwardly from an axial end surface 65 and a generally annular elastomeric sealing member 66 is disposed within the groove 64. The sealing member 66 is configured to engage with an outer portion of the rotary sealing surface 16 to seal a radial space between the cover member 30 and the rotary seal member 12. Further, the sealing member 60 functions generally as a “dust” seal and preferably includes a plurality of circumferential beads 67.

Referring now to FIG. 8, in the fourth seal assembly construction, the seal assembly 10 again does not include a separate base member, and the rotary seal member 12 also functions as a “seat” for a bearing inner race 82, as described below. Specifically, the rotary seal member 12 includes a generally annular body 70, which may be an integral shoulder or flange of the shaft 2, disposed generally beneath the bearing inner race 82. Further, with the fourth seal assembly construction, the cover member 30 has a second annular groove 72 extending radially outwardly from the shoulder inner surface 39 and the seal assembly 10 further comprises an annular elastomeric sealing member 74 disposed within the groove 72. The sealing member 74 is configured to seal the space between the shoulder 38 and the shaft 2, and preferably includes a plurality of circumferential beads 75.

Referring again to FIGS. 1-10, as discussed above, the seal assembly 10 is preferably incorporated in bearing assembly 11 including a bearing 80 for supporting the shaft 2 within the bore 3 of the housing 1. The bearing 80 includes an inner race 82 coupled with the shaft 2, an outer race 84 coupled with the housing 1 and a plurality of rolling elements 86 disposed between the inner and outer races 82, 84. The seal assembly 10 is disposed at least partially within the bore 3 between the bearing 80 and one axial end 1a of the housing 1 and is configured to substantially prevent substances from passing through the bore 3 between the bearing 80 and the housing axial end 1a. In certain seal assembly constructions, at least one seal assembly component functions to axially retain either the bearing inner race 82 or the bearing outer race 84; for example, in the second construction, the base member 40 retains the bearing inner race 82 and the cover 30 retains the bearing outer race 84, and in the third construction, the rotary seal member 12 retains the bearing inner race 82. Further, with the preferred application of the sealing assembly 10 incorporated into a bearing assembly 11, the bearing assembly 11 may be utilized in any appropriate machine or device, such as for example, a high speed train gear box, an “Agri hub”, a centrifugal pump, a motor, or any other application which uses a bearing to rotatably support a shaft. Furthermore, the sealing assembly 10 may be used to seal the space between a rotating shaft and a housing remotely from any bearing.

Having described the structure in detail above, the preferred materials for certain components of the seal assembly 10 are now discussed, which vary depending on the service or operating conditions. For a standard operating environment, the rotary seal member 14 is preferably formed of stainless steel, the static seal member 14 is preferably formed of PTFE carbon graphite, the cover member 30 is preferably formed of PTFE carbon graphite, and the various elastomeric sealing members 20, 45, 49, 58, 66 and 74 are preferably formed of FPM 80 shore A. For abrasive operating conditions, the rotary seal member 14 is preferably formed of tungsten carbide, the static seal member 14 is preferably formed of silicon carbide, the cover member 30 is preferably formed of carbon steel, and the elastomeric sealing members 20, 45, 49, 58, 66 and 74 are preferably formed of Polyurethane S ECOPUR. Further, for a chemical process environment, the rotary seal member 14 is preferably formed of silicon carbide, the static seal member 14 is preferably formed of PTFE carbon graphite, the cover member 30 is preferably formed of PTFE carbon graphite, and the sealing members 20, 45, 49, 58, 66 and 74 are preferably formed of FPM or FFPM 80 shore A. Although the previously listed materials are presently preferred, it is within the scope of the present invention to utilize any other appropriate material for any component of the seal assembly 10.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

I claim:

1. A seal assembly for sealing a space between a housing and a shaft, the housing having a bore with centerline and the shaft being disposed within the bore and rotatable about a central axis, the seal assembly comprising:
a generally annular rotary seal member coupled with the shaft and having a generally radial rotary sealing surface
a generally annular static seal member coupled with the housing, disposed about the shaft and having a generally radial static sealing surface disposed generally against the rotary sealing surface so as to substantially prevent passage of substances between the two sealing surfaces, the rotary sealing surface being slideable against the static sealing surface as the shaft rotates about the central axis, the static member being movable with respect to the housing such that the rotary and static sealing surfaces are substantially juxtaposed when the shaft axis defines an acute angle with respect to the housing centerline.

2. The seal assembly as recited in claim 1 wherein the static seal member has inner and outer circumferential surfaces and is sized such that an outer clearance space is defined between the static member outer surface and an inner surface of one of the housing and a cover member connected with the housing and an inner clearance space is defined generally between the static member inner surface and the shaft, the static member being movable within the outer and inner clearance spaces so as to adjustably position the static member with respect to the housing centerline.

3. The seal assembly as recited in claim 3 further comprising a generally annular elastomeric sealing member disposed generally between the static seal member and the inner surface of the one of the housing and the cover member, the elastomeric sealing member being configured to substantially prevent passage of substances through the outer clearance space and to generally radially support the static seal member about the shaft, the static seal member being slidable within the elastomeric sealing member when moving within the inner and outer clearance spaces.

4. The seal assembly as recited in claim 3 wherein the elastomeric sealing member is further configured to substantially prevent angular displacement of the static seal member about the central axis.

5. The seal assembly as recited in claim 1 further comprising a biasing member configured to bias the static seal member generally toward the rotary seal member so as to maintain a contact pressure between the static member sealing surface and the rotary member sealing surface.

6. The seal assembly as recited in claim 1 wherein the static seal member includes at least one generally circumferential bead extending generally axially from the static sealing surface and engageable with the rotary sealing surface.

7. The seal assembly as recited in claim 1 further comprising a generally annular cover member disposed about the shaft, connected with the housing, and having a bore configured to receive at least a portion of the static seal member so as to couple the static member with the housing.

8. The seal assembly as recited in claim 7 further comprising at least one coupler configured to movably couple the static seal member with the housing.

9. The seal assembly as recited in claim 8 wherein:
one of the static seal member and the cover member includes two axially-extending slotted openings spaced apart circumferentially about the housing centerline; and
the seal assembly includes two couplers spaced circumferentially about the housing centerline, each coupler including a shaft having a first end disposed within a separate one of the slotted openings and a second end fixedly connected with the other one of the static seal member and the cover member.

10. The seal assembly as recited in claim 7 wherein:
the static seal member has opposing first and second axial ends, the static sealing surface being provided on the first axial end;
the cover member has a generally radial surface facing generally toward the static seal member; and
the seal assembly further comprises a biasing member extending generally between the cover member radial surface and the second end of the static seal member and configured to bias the static seal member generally toward the rotary seal member so as to maintain a contact pressure between the static and dynamic sealing surfaces.

11. The seal assembly as recited in claim 10 wherein the biasing member includes a spring washer.

12. The seal assembly as recited in claim 1 further comprising a base member mounted on the shaft and configured to connect the rotary seal member with the shaft.

13. The seal assembly as recited in claim 12 wherein the base member includes a generally cylindrical body having a central bore configured to receive a portion of the shaft such that the shaft extends through the base and the base is connected with the shaft, the base bore having a counter-bore section configured to receive at least a portion of the rotary seal member so as to couple the rotary seal member with the shaft.

14. The seal assembly as recited in claim 13 further comprising a generally annular elastomeric seal member disposed within the base counter-bore section generally between the rotary seal member and the base, configured to substantially prevent passage of substances between the rotary seal member and the base, and configured to substantially prevent angular displacement of the static seal member about the central axis.

15. The seal assembly as recited in claim 12 wherein the static seal member has a central bore and the base member includes a generally annular body disposed at least partially within the static member bore and having inner and outer circumferential surfaces and a shoulder extending generally radially outwardly from the outer surface and circumferentially about the shaft axis, the base member inner surface defining a central bore configured to receive a portion of the shaft such that the shaft extends through the base and the base is connected with the shaft, the shoulder having a generally radial stop surface, the rotary seal member being disposed about the base outer surface and having an axial end disposed generally against the shoulder stop surface such that the shoulder axially retains the seal member.

16. The seal assembly as recited in claim 15 wherein the seal assembly further comprises a generally annular seal member configured to substantially prevent passage of substances between the rotary seal member and the base member outer surface and configured to substantially prevent angular displacement of the static seal member about the central axis.

17. The seal assembly as recited in claim 1 wherein the static seal member has a central bore and the rotary seal member includes a generally axial portion disposed at least partially within the static member bore and a generally radial portion providing the rotary sealing member surface, the axial portion having an inner circumferential surface defining a central bore configured to receive a portion of the shaft such that the shaft extends through the rotary member.

18. The seal assembly as recited in claim 17 wherein:
the seal assembly further comprises a generally annular cover member disposed about the shaft, connected with the housing, and having an inner surface defining a bore configured to receive at least a portion of the static seal member so as to couple the static member with the housing; and
the static seal member has inner and outer circumferential surfaces and is sized such that an outer clearance space is defined between the static member outer surface and the cover member inner surface and an inner clearance space is defined generally between the static member inner surface and the outer surface of the rotary member axial portion, the static member being movable within the outer and inner clearance spaces so as to adjustably position the static member with respect to the housing centerline.

19. The seal assembly as recited in claim 18 further comprising a generally annular elastomeric sealing member disposed generally between the static seal member and the inner surface of the one of the housing and the cover member, the elastomeric sealing member being configured to substantially prevent passage of substances through the outer clearance space and to generally radially support the static seal member about the shaft, the static seal member being slidable within the elastomeric sealing member when moving within the inner and outer clearance spaces.

20. A bearing assembly for supporting a shaft within a housing, the housing having opposing axial ends and a bore with centerline and the shaft being disposed within the bore and rotatable about a central axis, the bearing assembly comprising:
a bearing including an inner race coupled with the shaft, an outer race coupled with the housing and a plurality of rolling elements disposed between the inner and outer races; and
a seal assembly disposed at least partially within the bore between the bearing and one axial end of the housing, configured to substantially prevent substances from passing through the bore between the bearing and the housing axial end, and including:
a generally annular rotary seal member coupled with the shaft and having a generally radial rotary sealing surface; and
a generally annular static seal member coupled with the housing, disposed about the shaft and having a generally radial static sealing surface disposed generally against the rotary sealing surface so as to substantially prevent passage of substances between the two sealing surfaces, the rotary sealing surface being slideable against the static sealing surface as the shaft rotates about the central axis, the static member being movable with respect to the housing such that the rotary and static sealing surfaces are substantially juxtaposed when the shaft axis defines an acute angle with respect to the housing centerline.
